(19) United States
(12) Patent Application Publication
(10) Pub. No.: US 2017/0225664 A1
(43) Pub. Date: Aug. 10, 2017

(54) FEEDBACK THROUGH BRAKE INPUTS

(71) Applicant: Jaguar Land Rover Limited, Coventry (GB)

(72) Inventor: Paul Beever, Coventry (GB)

(21) Appl. No.: 15/329,406

(22) PCT Filed: Jun. 30, 2015
(86) PCT No.: PCT/EP2015/064807

§ 371 Date: Jan. 26, 2017

(30) Foreign Application Priority Data
Jul. 30, 2014 (GB) 1413477.9

(51) Int. Cl. B60T 7/04; B60T 13/68; B60T 8/40

(52) U.S. Cl. CPC B60T 7/042; B60T 8/4081; B60T 13/686; B60T 2270/82

(57) ABSTRACT

A brake system for a vehicle having wheels. The brake system (4) comprises: a brake assembly (8) for supplying a braking effort to the wheels on actuation of the brake assembly and brake input means (20) co-operable to actuate the brake assembly via a brake-by-wire connection. The brake input means are connected to decoupling means (26, 34) for hydraulically decoupling the brake input means from at least one of the brake assembly and a brake simulator (28). A controller (10) is configured for sending, in dependence on a defined condition, a feedback command to the decoupling means to actuate the decoupling means and thereby impart haptic feedback to the brake input means. A method of imparting haptic feedback is also described as are software and processor.

### TECHNICAL FIELD

This invention relates to brake feedback in brake-by-wire systems. In particular, though not exclusively, this invention relates to haptic feedback through brake inputs in vehicle brake systems with decoupled brakes. Aspects of the invention also relate to vehicles comprising such systems, methods of providing brake feedback, and to relevant controllers, software and processors.

### BACKGROUND

In brake-by-wire braking, mechanical force applied to a brake input, such as a brake pedal, is transmitted to one or more brakes via an electrical signal, optionally wirelessly. The electrical signal is calculated based on detected driver input and may be used to control a hydraulic circuit that uses hydraulic pressure to apply the vehicle brakes, or may use other brake actuation methods, e.g. direct electric actuation.

A pedal/brake simulator is typically active during brake-by-wire operation to simulate pedal feedback characteristics (resistance/travel), corresponding to the feedback a driver would experience in a traditional, fully hydraulic brake system.

Brake-by-wire systems allow for hydraulic decoupling of the brake input from their brake(s). Such brake systems may be configured to operate solely in a brake-by-wire mode, or may comprise an interruptible hydraulic brake connection for hydraulic augmentation of brake-by-wire and/or redundancy. Brake systems in which a hydraulic coupling is employed in addition to electromechanical braking effort are also known as auxiliary force brake systems. Most brake-by-wire systems are configured such that, if brake-by-wire fails, braking effort can be supplied via a hydraulic brake connection. Typically, any brake simulator is decoupled from the brake input in this scenario.

One beneficial application of brake-by-wire functionality, and in particular brake input decoupling, is in hybrid motor vehicles. Decoupling of the brake input facilitates blending of regenerative and friction braking efforts. In the absence of such blending, variable driver input would otherwise be required to complement varying regenerative braking effort.

A disadvantage of brake-by-wire functionality is that feedback from the brake(s) to the brake input is reduced. Indeed, when the brake input is decoupled from the brakes, mechanical feedback is entirely absent. Reduced or absent feedback may be disadvantageous, for example, where the brake system has anti-lock braking (ABS) functionality. In particular, anti-lock braking events may not be apparent to a driver from the brake input because the well-recognised ABS feedback in the brake input, resultant from the pulsed hydraulic fluid in an ABS intervention event, is absent.

It is an object of the invention to provide brake-by-wire systems and methods offering effective feedback in a brake input and/or solving at least one problem with the prior art.

### SUMMARY OF THE INVENTION

Aspects of the invention relate to a brake system comprising: brake input means; and decoupling means for hydraulically decoupling the brake input means from one or more other parts of the brake system, the decoupling means being controlled by a controller to impart haptic feedback to the brake input means.

According to an aspect of the invention there is provided a brake system for a vehicle having wheels, the brake system comprising: a brake assembly for supplying a braking effort to the wheels on actuation of the brake assembly; brake input means co-operable to actuate the brake assembly via a brake-by-wire connection, the brake input means being connected to decoupling means for hydraulically decoupling the brake input means from at least one of the brake assembly and a brake simulator; and a controller configured for sending, in dependence on a defined condition, a feedback command to the decoupling means to actuate the decoupling means and thereby impart haptic feedback to the brake input means.

Advantageously, the brake system enables decoupling of the brake input means, as well as the provision of haptic feedback to the brake input means. Feedback may be provided without the need for a dedicated component, thereby saving weight and cost.

The brake input means may comprise or consist of a brake input. Conveniently, the brake input means may comprise a brake pedal. The brake input means is co-operable with the brake assembly via a brake-by-wire connection. The brake-by-wire connection enables movement of the brake input means to cause actuation of the brake assembly without the need for mechanical/hydraulic coupling of the brake input means to the brake assembly. Conveniently, the brake input means may be configured to send a signal representative of brake input actuation to the controller, which may in turn be configured to actuate the brake assembly.

The decoupling means may comprise or consist of any suitable decoupler or decouplers. Conveniently, the decoupling means may comprise a decoupling valve, in particular a solenoid valve. In an embodiment, the decoupling means is movable, and may be actuated between a first state, in which the brake input means is hydraulically decoupled, and a second state, in which the brake input means is hydraulically coupled. Suitably, the decoupling means may be electromechanically movable/actuated, in particular between the first and second states. Advantageously, the decoupling means may be configured for oscillating interrupting or decoupling movement. In an embodiment, the decoupling means is configured for oscillating movement between the first and second states, optionally oscillating movement at a frequency of at least 1 Hz, in particular at least 10 Hz or at least 100 Hz.

The brake system may comprise a hydraulic connection linking the brake input means to a part of the brake system from which it may be decoupled, in particular the brake assembly and/or a brake simulator. In an embodiment, the hydraulic connection comprises a master cylinder for converting movement of the brake input means into hydraulic fluid pressure in a hydraulic channel of the connection. The hydraulic connection may further comprise a slave cylinder for converting hydraulic fluid pressure in the hydraulic channel into actuation in said part of the brake system from which the brake input means may be decoupled.

The brake assembly may comprise or consist of one or more brakes. The brakes may in particular be friction brakes, for example disc brakes or drum brakes. In an embodiment, the brake assembly is a hydraulic brake assembly comprising or consisting of one or more hydraulic brakes actuated by hydraulic fluid. In an embodiment, the brake assembly comprises a slave cylinder for converting hydraulic fluid pressure into brake actuation.

In an embodiment, the brake input means is co-operable to actuate the brake assembly via a hydraulic brake connection. The decoupling means may then hydraulically decouple the brake input means from the brake assembly.

In particular, the decoupling means may comprise a brake decoupling valve for hydraulically decoupling the brake input means from the brake assembly. In an embodiment, the brake decoupling valve is configured not to interrupt the hydraulic brake connection in a default state, i.e. to leave the brake input means hydraulically coupled to the brake assembly in the default state. The default state of the brake decoupling valve may, for example, be an electromechanical default state in the absence of a command and/or power. This may advantageously enhance safety by ensuring that hydraulic coupling of the brake input means and the brake assembly is provided by default and is interrupted/decoupled only when desired.

In an embodiment the brake input means is hydraulically connected to a brake simulator for simulating brake feedback in the brake input means. The decoupling means may then comprise a simulator decoupling valve for decoupling the brake input means from the brake simulator. Suitably, the simulator may be arranged to simulate one or more characteristics, such as resistance and/or travel of the brake input means.

In an embodiment, the brake simulator is a hydraulic brake pedal simulator. The hydraulic brake pedal simulator may suitably comprise a chamber of variable volume configured for receiving hydraulic fluid from a master cylinder associated with the brake input means, for example to simulate in the brake input means the feel of a hydraulically coupled brake pedal. The simulator decoupling valve may be useful particularly when a hydraulic connection is established between the brake input means and the brake assembly. In an embodiment, the simulator decoupling valve is configured to decouple the brake input means from the brake simulator in a default state. The default state of the simulator decoupling valve may, for example, be an electromechanical default state in the absence of a command and/or power.

In an embodiment, the system comprises brake actuation means for actuating the brake assembly in dependence upon a brake command from the controller. The brake command may advantageously be non-mechanical, in particular an electrical signal. In an embodiment, the brake command comprises a signal representative of brake input actuation and/or a desired braking effort. In an embodiment, the brake actuation means is configured for receiving and executing a brake command, e.g. comprising a signal representative of brake input actuation and/or a desired braking effort, from the controller. In an embodiment, the brake actuation means is configured for increasing or reducing the braking effort applied by the brake assembly in dependence on a brake increase or reduction command from the controller.

In an embodiment, the brake actuation means comprises a pump configured to generate hydraulic fluid pressure for actuating the hydraulic brake assembly. Advantageously, the brake actuation means may comprise one or more release valves and/or reservoirs for hydraulic fluid for reducing hydraulic fluid pressure actuating the hydraulic brake assembly. The pump and/or release valves may be controlled by the controller.

The controller or controllers described herein may suitably comprise a control unit or computational device having one or more electronic processors. Thus the system may comprise a single control unit or electronic controller or alternatively different functions of the controller may be embodied in, or hosted in, different control units or controllers. As used herein the term “controller” or “control unit” will be understood to include both a single control unit or controller and a plurality of control units or controllers collectively operating to provide any stated control functionality. To configure a controller, a suitable set of instructions may be provided which, when executed, cause said control unit or computational device to implement the control techniques specified herein. The set of instructions may suitably be embedded in said one or more electronic processors. Alternatively, the set of instructions may be provided as software to be executed on said computational device. A first controller may be implemented in software run on one or more processors. One or more other controllers may be implemented in software run on one or more processors, optionally the same one or more processors as the first controller. Other suitable arrangements may also be used.

The controller is configured for sending, in dependence on a defined condition, a feedback command to the decoupling means to actuate the decoupling means to impart haptic feedback to the brake input means.

In an embodiment, the defined condition is the occurrence of a traction control or braking event. In an embodiment, the defined condition is an automated event. In an embodiment, the braking event comprises an automated rise and/or fall in braking effort supplied by the brake assembly, e.g. caused by operation of the brake actuation means. In an embodiment, the brake assembly is hydraulic and the braking event comprises an automated rise/and or fall in hydraulic pressure of fluid actuating the brake assembly. In an embodiment, the braking event comprises a plurality of automated rises and/or falls in braking effort or hydraulic pressure. In an embodiment, the defined condition is an anti-lock braking (ABS) event. The determination of such events by vehicle controllers is known in the art. In an embodiment, the system comprises one or more sensors configured for sensing information related to the defined condition and for sending information related to the defined condition to the controller.

The feedback command sent by the controller to the decoupling means causes the decoupling means to actuate and thereby impart haptic feedback to the brake input means. The feedback command thus causes the decoupling means to execute a feedback actuation to impart the haptic feedback to the brake input. In an embodiment, the feedback actuation of the decoupling means is associated with an actuation profile representing a characteristic of the feedback actuation of the decoupling means. In an embodiment, the actuation profile comprises information about one or more of: duration, amplitude and frequency of the feedback actuation of the decoupling means. In an embodiment, the feedback command comprises the actuation profile. In an embodiment, the actuation profile is obtained by the controller by querying a lookup table based on the defined condition. In an embodiment, the lookup table comprises a plurality of defined conditions each associated with or mapped against an actuation profile.

In an embodiment, the feedback command causes the decoupling means to execute a feedback actuation imparting haptic feedback related to, or simulating, the defined condition. For example, the defined condition may be an ABS braking event and the haptic feedback imparted to the brake input means may comprise variable movement resistance and/or a distal travel of the brake input means. In an embodiment, the variable movement resistance comprises a pulsing or oscillating movement resistance of the brake input means.

In an embodiment, the controller is configured for sending the feedback command in dependence a detected travel state of the brake input means. In an embodiment, the controller is configured to omit sending the feedback command if a distal travel state of the brake input means is above a set threshold. This may help to enhance safety by avoiding haptic feedback where brake input travel is above the threshold, e.g. when a brake pedal has already travelled substantially and further travel as a result of the haptic feedback would not be desirable and/or possible.

In an embodiment, the feedback command causes the decoupling means to move between a first state, in which the brake input means is hydraulically decoupled, and a second state, in which the brake input means is hydraulically coupled. The amplitude of the feedback actuation may be determined by a distance of movement between the first and second states. In an embodiment, the feedback command causes the decoupling means to oscillate between said first and second states. The frequency of the feedback actuation may correspond to the frequency of such oscillation. In an embodiment, the feedback command causes the decoupling means to oscillate between said first and second states at a frequency of at least 1 Hz, in particular at least 10 Hz or at least 100 Hz. Oscillating movement of the decoupling means may advantageously lead to variable movement resistance, in particular pulsing or oscillating movement resistance in the brake input.

Where the decoupling means comprises a brake decoupling valve, a distal travel of the brake input may be achieved by movement of the valve from a first, closed state, in which fluid communication is blocked and in which the hydraulic connection between the brake input means and the brake assembly is therefore interrupted, into a second, open state, in which fluid communication is permitted and in which the hydraulic connection is therefore maintained. Distal travel of the brake input means may result, in particular, from hydraulic fluid passing the decoupling means. Pulsing feedback in the brake input means may additionally be achieved by oscillating movement between said first and second states. The feedback actuation may suitably comprise one or both of such movements, for example to simulate an ABS braking event.

The brake system may be installed in a vehicle in use. From another aspect, the invention provides a vehicle, in particular a motor vehicle, comprising a brake system as defined anywhere herein. The brake assembly of the brake system may be coupled to one or more wheels of the vehicle for supplying braking effort to said wheel(s). In an embodiment, the brake assembly is coupled to all wheels of the vehicle, e.g. four wheels. In an embodiment, the vehicle comprises a regenerative braking module. In an embodiment, the controller of the brake system, or another controller of the vehicle, is configured for blending regenerative braking effort supplied by the regenerative braking module and braking effort supplied by the brake assembly. In an embodiment, the regenerative braking module comprises an electric machine. In an embodiment the vehicle is an electric or a hybrid vehicle driven by said electric machine.

Aspects of the invention relate to a method of imparting haptic feedback to brake input means, the feedback being imparted by decoupling means for decoupling the brake input means from one or more other parts of a brake system.

A further aspect of the invention provides a method of providing haptic feedback to brake input means, the brake input means being co-operable to actuate a brake assembly of a vehicle via a brake-by-wire connection and being hydraulically decoupled from at least one of the brake assembly and a brake simulator by decoupling means, the method comprising actuating the decoupling means.

Advantageously, the brake input means, brake assembly, and decoupling means may each be as defined or described anywhere herein.

The method provides for haptic feedback via the brake input means. Advantageously, such haptic feedback may be provided even when the brake input means is decoupled.

In an embodiment, the method comprises actuating a brake decoupling valve of the decoupling means from a default state in which the brake input means is hydraulically decoupled from the brake assembly by said valve.

In an embodiment, the method comprises actuating a brake simulator valve of the decoupling means from a default state in which the brake input means is hydraulically coupled to a brake simulator for simulating brake feedback in the brake input means. Advantageously, the brake simulator may be as hereinabove defined.

In an embodiment, the method comprises actuating the brake assembly. In an embodiment, the method comprises actuating the brake assembly in dependence on a movement of the brake input means, via the brake-by-wire connection.

The defined condition may be as described or defined anywhere herein. In an embodiment, the defined condition is an ABS braking event.

In an embodiment, the method comprises receiving or determining information related to the defined condition. In an embodiment, the method comprises sensing said information related to the defined condition.

The actuation and/or haptic feedback may be as defined or described anywhere herein. In an embodiment, the decoupling means is actuated to impart haptic feedback that is related to, or simulates, the defined condition. In an embodiment, the defined condition is an ABS braking event and the decoupling means is actuated to impart haptic feedback comprising variable movement resistance and/or a distal travel of the brake input. In an embodiment, the variable movement resistance comprises a pulsing or oscillating movement resistance.

In an embodiment, the method comprises actuating the decoupling means in dependence on a detected travel state of the brake input means.

In an embodiment, actuating the decoupling means comprises oscillating the decoupling means between said first and second states, optionally at a frequency of at least 1 Hz, in particular at least 10 Hz or at least 100 Hz.

The method may advantageously be computer implemented. A further aspect of the invention embraces a carrier medium carrying computer readable code for controlling a vehicle or a vehicle brake system to carry out the method. Yet another aspect of the invention provides a computer program executable on a processor so as to implement the method. Still another aspect of the invention provides a computer readable medium loaded with the computer program. The invention also embraces a processor arranged to implement the method or the computer program.

Other optional features of the invention will be apparent from the detailed description below.

Throughout the description and claims of this specification, the words “comprise” and “contain” and variations of the words, for example “comprising” and “comprises”, mean “including but not limited to”, and do not exclude other components, integers or steps. Moreover the singular encompasses the plural unless the context otherwise requires: in particular, where the indefinite article is used, the specification is to be understood as contemplating plurality as well as singularity, unless the context requires otherwise.

Preferred features of each aspect of the invention may be as described in connection with any of the other aspects. Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. The applicant reserves the right to change any originally filed claim or file any new claim accordingly, including the right to amend any originally filed claim to depend from and/or incorporate any feature of any other claim although not originally claimed in that manner.

### BRIEF DESCRIPTION OF THE DRAWINGS

One or more embodiments of the invention will now be described, by way of example only, with reference to the accompanying drawings in which:

FIG. 1, which is a schematic side view of a vehicle comprising a brake system in accordance with one embodiment of the invention; and

FIG. 2 is a more detailed schematic view of the brake system of FIG. 1.

### DETAILED DESCRIPTION

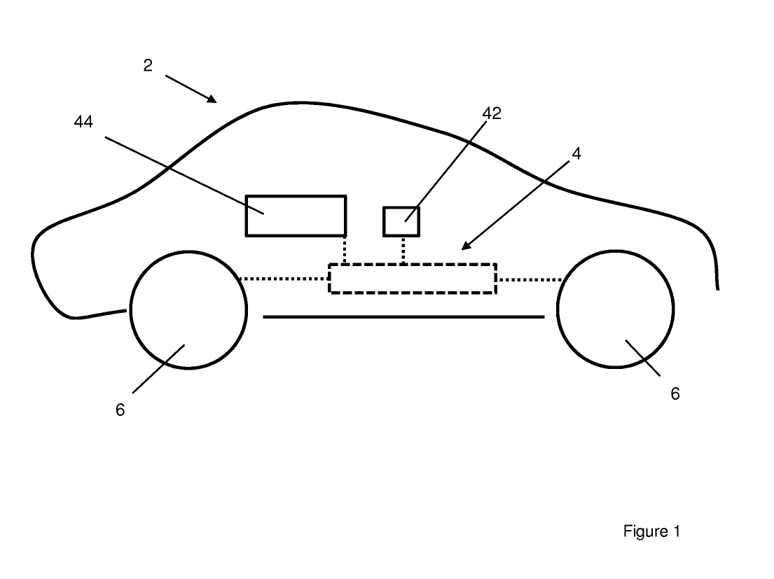

With reference to FIG. 1, in one embodiment of the invention, a hybrid motor vehicle 2 comprises a brake system 4. The vehicle 2 comprises four wheels 6, to which a braking effort may be supplied by the brake system 4.

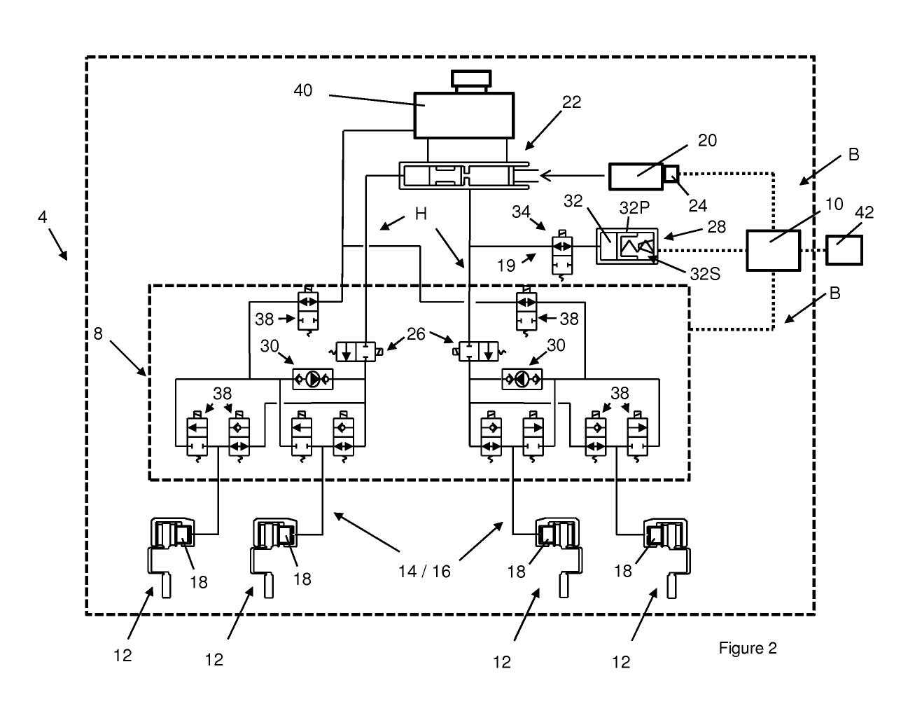

Referring now to FIG. 2, the brake system 4 comprises a hydraulic brake assembly 8 which may be actuated to supply the braking effort. The hydraulic brake assembly 8 and other parts of the brake system 4 are controlled by a controller 10 comprising a control unit or computational device having one or more electronic processors.

The brake assembly 8 comprises four disc brakes 12, one in each wheel 6 of the vehicle, actuated by hydraulic fluid 14 supplied under pressure by hydraulic fluid lines/channels 16. Each brake 12 comprises a slave cylinder 18 for converting hydraulic fluid pressure into brake actuation/effort.

The brake system 4 comprises a brake input means in the form of a brake pedal 20. The brake pedal 20 is hydraulically coupled with the brake assembly 8 via hydraulic connections (H) through the hydraulic fluid lines 16. The hydraulic connections H comprise a master cylinder 22 co-operable with the brake pedal 20 arranged to convert movement of the brake pedal 20 into hydraulic fluid pressure in the hydraulic lines 16. A pedal displacement sensor 24 detects pedal displacement and sends a signal representative of pedal displacement to the controller 10.

The hydraulic connection H is interruptible by a decoupling means in the form of first and second brake decoupling valves 26 configured for receiving and executing commands from the controller 10. The brake decoupling valves 26 are solenoid valves disposed in the hydraulic fluid lines 16 of the hydraulic connection H to selectively block hydraulic fluid communication between the brake pedal 20 and the brake assembly 8. The brake decoupling valves 26 are each disposed between the master cylinder 22 and two of the brakes 12. The brake decoupling valves 26 are each electromechanically movable between a first, closed state, in which fluid communication is blocked and in which the brake pedal 20 is therefore hydraulically decoupled from the brake assembly 8, and a second, open state, in which fluid communication is permitted and in which the brake pedal 20 is hydraulically coupled to the brake assembly 8.

The brake decoupling valves 26 are configured to hydraulically couple the brake pedal 20 and the brake assembly 8 in an electromechanical default state, thus adopting the second state by default. This enhances safety by ensuring that mechanical coupling of the brake pedal 20 and the brake assembly 8, in particular the brakes 12, is provided by default and is interrupted only when desired.

The brake pedal 20 can thus be connected selectively via the hydraulic fluid lines 16 to the brakes 12 by opening the brake decoupling valves 26 to enable direct actuation of the brakes 12 by movement of the brake pedal 20.

The brake pedal 20 is also coupled with the brake assembly 8 via a brake-by-wire connection B, via the controller 10 and first and second hydraulic fluid pumps 30, each in hydraulic communication with two of the brakes 12.

The pumps 30 actuate the brakes 12 of the brake assembly 8 in dependence upon a brake command from the brake controller 10. Each of the hydraulic fluid pumps 30 is in communication with its associated brakes 12 via the hydraulic fluid lines 16, the pumps 30 being driven to generate hydraulic fluid pressure in the hydraulic fluid lines 16 for actuating the hydraulic brakes 12. The pumps 30 may generate hydraulic fluid pressure by pumping additional hydraulic fluid 14 into the hydraulic lines 16 from a brake fluid reservoir 40. The hydraulic pressure in the hydraulic fluid lines 16 may also be reduced by the controller 10 actuating control valves 38 in the hydraulic fluid lines 16 to allow fluid to flow from the lines 16.

When the brake decoupling valves 26 are in their closed state, the brake-by-wire connection allows the brake pedal 20 to actuate the brake assembly 8, in particular the brakes 12 thereof. Specifically, the brake pedal position sensor 22 detects movement of the brake pedal 20 and sends a signal to the controller 10, and the controller 10 sends a signal to the pumps 30 and/or control valves to enhance or reduce hydraulic pressure in the hydraulic lines 16 thereby actuating the brakes 12. The controller 10 may also cause the pumps 30 and control valves 38 to perform automated braking events and/or to reduce or increase the braking effort demanded by the brake pedal 20.

The brake pedal 20 is hydraulically coupled with a hydraulic brake pedal simulator 28 via the master cylinder 22 and a hydraulic simulator line 19. The brake pedal simulator 28 simulates characteristics or feel in the brake pedal 20, including resistance and travel. The characteristic are varied by the brake simulator 28 in dependence upon actuation of the brake pedal. The hydraulic brake pedal simulator 28 comprises a chamber of variable volume 32 configured for receiving hydraulic fluid 14 from the master cylinder 22. The chamber 32 has a piston 32P therein that is moved by the hydraulic fluid 14 as the fluid 14 is forced into the chamber 32 by movement of the pedal 20. Within the brake simulator 28 the piston 32P acts against a composite metal coil and elastomer spring 32S to give a rising rate of resistance, thereby to simulate the feel of the natural resistance felt in a traditional brake pedal 20.

The brake pedal simulator 28 may be decoupled from the brake pedal 20 with the help of a simulator decoupling valve 34 controlled by the controller 10. The simulator decoupling valve 34 is a solenoid valve disposed in the hydraulic line 19 connecting the brake pedal 20 and the brake pedal simulator 28, and is configured to decouple, i.e. interrupt the fluid pathway between, the hydraulic brake pedal simulator 28 and the master cylinder 22 in a default, unpowered state.

The brake decoupling valves 26 are open in their unpowered state, whereas the simulator decoupling valve 34 is closed in its unpowered state. In this manner, in a failure condition wherein electrical power is lost the brake decoupling valves 26 open and the pedal simulator valve 34 closes, thereby hydraulically connecting the brake pedal 20, via the master cylinder 22, directly to the vehicle brakes 12. The integrity of the brake system is hence not compromised by an electrical power failure.

The controller 10 comprises a control unit or computational device having one or more electronic processors and is configured for sending, in dependence on a defined condition, a feedback command to the brake decoupling valves 26 to actuate said valves 26 and thereby impart haptic feedback to the brake pedal 20. If desired, only one of the brake decoupling valves can be actuated.

In this embodiment, the defined condition is the occurrence of a braking event, in particular an automated anti-lock braking (ABS) event. The event comprises a plurality of automated rises and falls in braking effort and hydraulic pressure in the hydraulic lines 16. However, it will be appreciated that the defined condition may be any other suitable condition, for example but not limited to an SCS (stability control system) braking event or an RSC (roll stability control) braking event.

The controller 10 is configured for receiving information related to the anti-lock braking event from vehicle sensors 42 in conventional fashion. The controller 10 determines from the received information whether the anti-lock braking event has occurred and, if the event occurs, sends the feedback command to the brake decoupling valves 26, provided that distal travel state of the brake pedal 20 does not already exceed a set safety threshold. This functionality is provided so that the pedal does not move too far and bottom out, which would be undesirable.

The feedback command causes the brake decoupling valves 26 to perform a feedback actuation and thereby impart haptic feedback to the brake pedal 20. The command comprises an actuation profile representing a characteristic of the feedback actuation of the brake decoupling valves 26, in particular duration, amplitude and frequency of the feedback actuation. The actuation profile is obtained by the controller 10 by querying a lookup table comprising a plurality of defined conditions each associated with or mapped against an actuation profile.

The feedback command causes the brake decoupling valves 26 to execute the feedback actuation so as to impart haptic feedback that is related to, or simulates, the anti-lock braking event. In particular, the haptic feedback comprises actuating the brake decoupling valves 26 in a pulsed manner that will cause the brake pedal 20 to move forward in small, pulsed increments as fluid is released from the master cylinder 22 into the hydraulic lines 16.

In one routine, receiving the feedback command, the solenoid valve 26 oscillates between its first and second states at a frequency of between 0.5 and 20 Hz for a time period of 1 second. Alternatively the feedback command may cause the valve to oscillate for the duration of the anti-locking braking event. As aforesaid, this oscillation causes pulsed, short distance travel of the brake pedal 20, thus simulating the anti-lock braking event.

In this embodiment the brake controller 10 is also configured to perform other brake control functions. In particular, the anti-lock braking event may be initiated by the controller 10 in dependence on information received from one or more vehicle systems. Referring again to FIG. 1, as the vehicle 2 in this embodiment is a hybrid vehicle, the controller 10 is also configured to blend regenerative braking effort supplied by an electric motor 44 of the vehicle 2 with braking effort from the brake assembly 8. However, it will be appreciated that the controller 10 need not perform such auxiliary functions, and indeed that the vehicle 2 need not be a hybrid vehicle.

The system 4 is advantageously capable of providing haptic feedback to the brake pedal 20 by interrupting a hydraulic connection between the brake pedal 20 and the brake assembly 8. The system may thus operate in a brake-by-wire mode, in which the brake pedal 20 is hydraulically decoupled from the brake assembly 8, but in which the system 4 provides haptic feedback to the brake pedal 20 about ABS braking events by rapid opening and closing of the brake decoupling valves 26. If the brake-by-wire connection fails, for example due to a power cut, the brake decoupling valves 26 open and the simulator decoupling valve 34 closes, such that the system 4 allows braking through the hydraulic connection H.

It will be appreciated that a number of modifications can be made to the above embodiment without departing from the scope of the invention as defined in the appended claims. A range of equivalent components with suitably similar functions may be used to implement the hydraulic and brake-by-wire connections. The functioning of the system may also be readily modified.

For example, as alternative approach to providing haptic feedback, the simulator decoupling valve 34 can be actuated instead of, or in addition to, the brake decoupling valves to achieve haptic feedback. This may be of particular benefit, for example, if hydraulic fluid pressures in the master cylinder 22 and in the hydraulic line 16 are roughly equal to one another, in which case pulsing the brake decoupling valve 26 would have less effect. Furthermore, such operation can enable haptic feedback in pure brake-by-wire systems, i.e. with no non-electric link between the brake pedal 22 and the brakes 12.

Some aspects and embodiments of the invention are described in the following paragraphs:
1. A brake system for a vehicle having wheels, the brake system comprising: a brake assembly for supplying a braking effort to the wheels on actuation of the brake assembly; a brake input co-operable to actuate the brake assembly via a brake-by-wire connection, the brake input being connected to a decoupler for hydraulically decoupling the brake input from at least one of the brake assembly and a brake simulator; and an electronic controller configured for sending, in dependence on a defined condition, a feedback command to the decoupler to actuate the decoupler and thereby impart haptic feedback to the brake input.
2. The brake system of paragraph 1, wherein the decoupler is electromechanically movable and is actuated to oscillate between a first state, in which the brake input is hydraulically decoupled, and a second state, in which the brake input is hydraulically coupled.
3. The brake system of paragraph 1, wherein the brake input is co-operable to actuate the brake assembly via a hydraulic brake connection and the decoupler hydraulically decouples the brake input from the brake assembly.
4. The brake system of paragraph 3, wherein the decoupler comprises a brake decoupling valve for hydraulically decoupling the brake input from the brake assembly, the brake decoupling valve being configured to leave the brake input hydraulically coupled to the brake assembly in a default state.
5. The brake system of paragraph 1, wherein the brake input is hydraulically connected to a brake simulator for simulating brake feedback in the brake input.
6. The brake system of paragraph 5, wherein the decoupler comprise a simulator decoupling valve for decoupling the brake input from the brake simulator.
7. The brake system of paragraph 6, wherein the simulator decoupling valve is configured to decouple the brake input from the brake simulator in a default state.
8. The brake system of paragraph 1, wherein the defined condition is an anti-lock braking (ABS) event and the decoupler is actuated to impart haptic feedback comprising pulsing resistance and/or a distal travel of the brake input.
9. The brake system of paragraph 1, wherein the controller is configured to omit sending the feedback command if a distal travel state of the brake input is above a set threshold.
10. A brake system for a vehicle having wheels, the brake system comprising: a brake assembly for supplying a braking effort to the wheels on actuation of the brake assembly; brake input co-operable to actuate the brake assembly via a brake-by-wire connection and optionally via a hydraulic brake connection, the brake input means being connected to electromechanically movable decoupler configured for hydraulically decoupling the brake input from the brake assembly; and a controller configured for sending, in dependence on an ABS braking event, a feedback command to the decoupler to actuate the decoupler to oscillate between a first state, in which the brake input is hydraulically decoupled, and a second state, in which the brake input is hydraulically coupled, and thereby impart haptic feedback to the brake input, the feedback comprising pulsing resistance and/or a distal travel of the brake input.
11. A motor vehicle comprising a plurality of wheels and a brake system according to paragraph 1, the brake assembly of the brake system being coupled to one or more wheels of the vehicle for supplying braking effort to said wheels.
12. A vehicle according to paragraph 11 comprising a regenerative braking module, wherein the controller of the brake system, or another controller of the vehicle, is configured for blending regenerative braking effort supplied by the regenerative braking module and braking effort supplied by the brake assembly of the brake system.
13. A method of providing haptic feedback to a brake input, the brake input being co-operable to actuate a brake assembly of a vehicle via a brake-by-wire connection and being hydraulically decoupled by decoupler, the method comprising actuating the decoupler.
14. The method of paragraph 13 comprising at least one of: actuating a brake decoupling valve of the decoupler from a default state in which the brake input is hydraulically decoupled from the brake assembly by said valve; and actuating a brake simulator valve of the decoupler from a default state in which the brake input is hydraulically coupled to a brake simulator for simulating brake feedback in the brake input.
15. The method of paragraph 14 wherein the defined condition is an ABS braking event and the decoupler is actuated to impart haptic feedback comprising pulsing resistance and/or a distal travel of the brake input.
16. The method of paragraph 13 comprising actuating the decoupler in dependence on a detected travel state of the brake input.
17. A carrier medium carrying computer readable code for controlling a vehicle or a vehicle brake system to carry out the method of paragraph 13.
18. A computer program executable on a processor so as to implement the method of paragraph 13.
19. A non-transitory computer readable medium loaded with the computer program of paragraph 18.
20. A processor arranged to implement the method of paragraph 14 or the computer program of paragraph 18.

1. A brake system for a vehicle having wheels, the brake system comprising:
a brake assembly configured to supply a braking effort to the wheels in response to actuation of the brake assembly;
a brake input configured to actuate the brake assembly via a brake-by-wire connection, wherein the brake input is connected to a decoupler that hydraulically decouples the brake input from at least one of the brake assembly and a brake simulator; and
a controller configured to send, in dependence on a defined condition, a feedback command to the decoupler to actuate the decoupler and thereby impart haptic feedback to the brake input.

2. The brake system of claim 1, wherein the decoupler is electromechanically movable and is actuated to oscillate between a first state, in which the brake input is hydraulically decoupled, and a second state, in which the brake input is hydraulically coupled.

3. The brake system of claim 1, wherein the brake input is configured to actuate the brake assembly via a hydraulic brake connection, and wherein the decoupler hydraulically decouples the brake input from the brake assembly.

4. The brake system of claim 3, wherein the decoupler comprises a brake decoupling valve for hydraulically decoupling the brake input from the brake assembly, and wherein the brake decoupling valve is being configured to leave the brake input hydraulically coupled to the brake assembly in a default state.

5. The brake system of claim 1, wherein the brake input is hydraulically connected to the brake simulator, and wherein the brake simulator simulates brake feedback to the brake input.

6. The brake system of claim 5, wherein the decoupler comprises a simulator decoupling valve configured to decouple the brake input means from the brake simulator.

7. The brake system of claim 6, wherein the simulator decoupling valve is configured to decouple the brake input from the brake simulator in a default state.

8-13. (canceled)

14. The brake system of claim 1, wherein the defined condition is an anti-lock braking event, and wherein the haptic feedback imparted to the brake input comprises pulsing movement resistance and/or a distal travel of the brake input.

15. The brake system of claim 1, wherein the controller is configured to omit sending the feedback command if a distal travel state of the brake input is above a set threshold.

16. A motor vehicle, comprising:
a plurality of wheels; and
a brake system comprising:
a brake assembly configured to supply a braking effort to one or more of the wheels in response to actuation of the brake assembly;
a brake input configured to actuate the brake assembly via a brake-by-wire connection, wherein the brake input is connected to a decoupler that hydraulically decouples the brake input from at least one of the brake assembly and a brake simulator; and
a controller configured to send, in dependence on a defined condition, a feed pack command to the decoupler to actuate the decoupler and thereby impart haptic feedback to the brake input.

17. The vehicle of claim 16, further comprising a regenerative braking module, wherein the controller of the brake system, or another controller of the vehicle, is configured to blend regenerative braking effort supplied by the regenerative braking module and braking effort supplied by the brake assembly of the brake system.

18. A method of providing haptic feedback to a brake input, wherein the brake input is configured to actuate a brake assembly of a vehicle via a brake-by-wire connection, and wherein the brake input is hydraulically decoupled from at least one of the brake assembly and a brake simulator by a decoupler, the method comprising actuating the decoupler to thereby provide haptic feedback to the brake input.

19. The method of claim 18, further comprising at least one of:
actuating a brake decoupling valve of the decoupler from a default state in which the brake input is hydraulically decoupled from the brake assembly by said brake decoupling valve; and
actuating a brake simulator valve of the decoupler from a default state in which the brake input is hydraulically coupled to a brake simulator for simulating brake feedback to the brake input.

20. (canceled)

21. The method of claim 18, wherein actuating the decoupler comprises actuating the decoupler to provide the haptic feedback in response to an anti-lock braking system (ABS) event, wherein the haptic feedback comprises pulsing resistance and/or a distal travel of the brake input.

22-23. (canceled)

24. The method of claim 18, further comprising actuating the decoupler in dependence on a detected travel state of the brake input.

25. A computer program product comprising a non-transitory computer readable storage medium having instructions that, when executed on a processor, cause the processor to control a vehicle or a vehicle brake system to carry out the method of claim 18.

26-32. (canceled)

33. A brake system for a vehicle having wheels, the brake system comprising:
a brake assembly configured to supply a braking effort to the wheels upon actuation of the brake assembly;
a brake input configured to actuate the brake assembly via a brake-by-wire connection and/or via a hydraulic brake connection, the brake input being connected to an electromechanically movable decoupler configured to hydraulically decouple the brake input from the brake assembly; and
a controller configured to send, in dependence on an anti-lock braking system (ABS) braking event, a feedback command to the decoupler to actuate the decoupler to oscillate between a first state, in which the brake input is hydraulically decoupled, and a second state, in which the brake input is hydraulically coupled, and thereby impart haptic feedback to the brake input, the feedback comprising pulsing resistance and/or a distal travel of the brake input.
